(19) United States
(12) Patent Application Publication
(10) Pub. No.: US 2025/0193616 A1
(43) Pub. Date: Jun. 12, 2025

(54) SOUNDBAR DEVICE, AUDIO SYSTEM, AND SETTING METHOD OF SOUNDBAR DEVICE

(71) Applicant: D&M Holdings Inc., Kanagawa (JP)

(72) Inventor: Hiroki Saito, Kanagawa (JP)

(21) Appl. No.: 18/845,313

(22) PCT Filed: Mar. 10, 2022
(86) PCT No.: PCT/JP2022/035864

§ 371 Date: Sep. 9, 2024

(30) Foreign Application Priority Data
Mar. 10, 2022 (JP) 2022-037300

(51) Int. Cl. H04R 29/00; H04R 1/02

(52) U.S. Cl. CPC H04R 29/001; H04R 1/025; H04R 2499/15

(57) ABSTRACT

[Problem] To provide a soundbar device capable of increasing a sound pressure while keeping favorable sound quality even in combined use with another speaker. [Solution] A soundbar device 1 has a configuration in which speakers of multiple channels are contained in the same housing, and has a both-sides output mode in which a left channel speaker 30-1 and a right channel speaker 30-2 of a television device 3 are also used. The soundbar device stores both-sides output mode acoustic profile information for outputting. to an audio signal to be reproduced. a frequency bandwidth that cannot be covered by acoustic characteristics of the left channel speaker 30-1 and the right channel speaker 30-2 of the television device 3, and corrects, when the own soundbar device 1 is set to the both-sides output mode, the audio signal output from speakers 10-1 to 10-4 of the multiple channels of the own soundbar device 1 in accordance with the both-sides output mode acoustic profile information.

### TECHNICAL FIELD

The present invention relates to a technology of setting a sound bar device.

### BACKGROUND ART

In recent years, home theater systems using a television device and a sound bar device have become widespread. A sound bar device is a speaker system configured to accommodate speakers of a plurality of channels in the same housing. Compared to installing a speaker for each channel individually, installation space efficiency is better and the installation work is easier. Therefore, through use of a sound bar device, a surround sound audio reproduction environment can be easily achieved even in an ordinary home with limited space (for example, Patent Literature 1).

### Citation List

### Patent Literature

[PTL 1] JP 2009-55450 A

### SUMMARY OF INVENTION

### Technical Problem

In recent years, television devices such as a liquid crystal display (LCD) and an organic electro luminescence (EL) display have been thinned, and a sound bar device to be used in combination therewith has also been thinned.

However, a thin-type sound bar device has a small capacity of a housing, and hence it is difficult to increase a sound pressure thereof. In this case, it is conceivable to use the sound bar device together with a built-in speaker of the television device to reinforce the sound pressure of the sound bar device. However, the sound bar device and the built-in speaker of the television device have different acoustic characteristics, and hence a sound quality may be degraded when both of the sound bar device and the built-in speaker of the television device are used together.

The present invention has been made in view of the above-mentioned circumstances, and has an object to provide a sound bar device capable of increasing a sound pressure while maintaining a good sound quality even in combined use with another speaker.

### Solution to Problem

In order to solve the above-mentioned problems, in the present invention, a sound bar device is set to output, with respect to an audio signal to be reproduced, a frequency band that is unable to be covered by an acoustic characteristic of an external speaker to be used together with the own sound bar device. In this case, the sound bar device may analyze an acoustic characteristic of an input audio signal, and collect this audio signal output from the external speaker by a microphone to analyze an acoustic characteristic thereof, to thereby identify the frequency band that is unable to be covered by the acoustic characteristic of the external speaker from a frequency band of this audio signal.

For example, according to one embodiment of the present invention, there is provided a sound bar device, which is configured to accommodate speakers of a plurality of channels in the same housing, and has a dual output mode of using the sound bar device together with an external speaker, the sound bar device including: acoustic profile information storage means for storing dual output mode acoustic profile information for outputting, with respect to an audio signal to be reproduced, a frequency band that is unable to be covered by an acoustic characteristic of the external speaker; and correction means for correcting, when the own sound bar device is set to the dual output mode, an audio signal to be output from the speakers of the plurality of channels in accordance with the dual output mode acoustic profile information stored in the acoustic profile information storage means.

### Advantageous Effects of Invention

In the present invention, when the sound bar device is used together with the external speaker, the sound bar device is set to output, with respect to the audio signal to be reproduced, the frequency band that is unable to be covered by the acoustic characteristic of the external speaker. Thus, it is possible to prevent output of a part of the frequency band from being emphasized and the sound quality from being degraded. Thus, according to the present invention, the sound pressure can be increased while a good sound quality is maintained even when the sound bar device is used together with another speaker.

### BRIEF DESCRIPTION OF DRAWINGS

FIG. 1 is a schematic configuration diagram of a home theater system in one embodiment of the present invention.

FIG. 2 is a schematic functional configuration diagram of a sound bar device (1).

FIG. 3(A) is a graph for showing a frequency characteristic example of an audio signal to be reproduced,

FIG. 3(B) is a graph for showing a frequency characteristic example of a built-in speaker (30) of a television device (3), and

FIG. 3(C) is a graph for showing a frequency characteristic example of dual output mode acoustic profile information.

FIG. 4 is a flow chart for illustrating operation of the sound bar device (1).

### DESCRIPTION OF EMBODIMENTS

One embodiment of the present invention is described below with reference to the drawings.

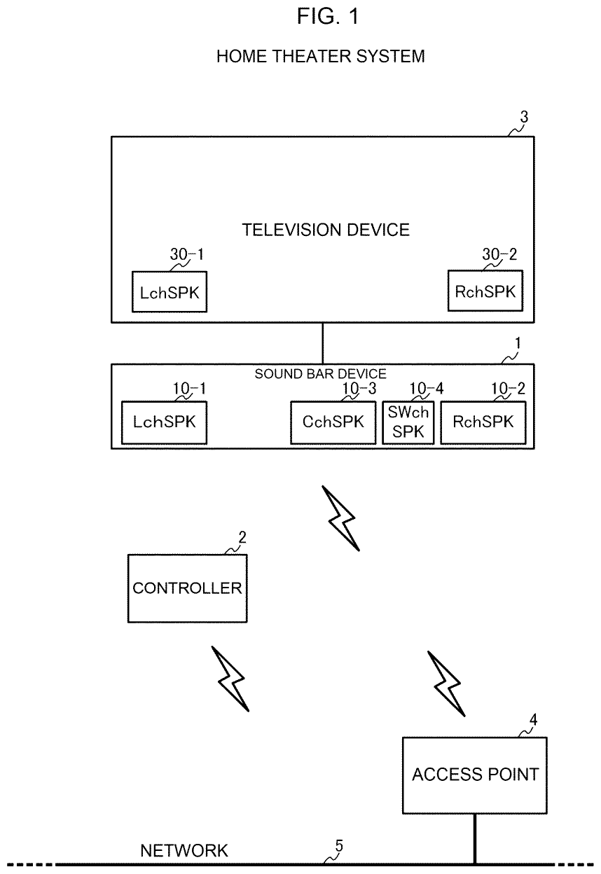

FIG. 1 is a schematic configuration diagram of a home theater system in this embodiment.

As illustrated in the figure, the home theater system in this embodiment includes a television device 3, a sound bar device 1, and a controller 2. The television device 3 includes a left channel speaker (LchSPK) 30-1 and a right channel speaker (RchSPK) 30-2 (hereinafter also simply referred to as “built-in speaker 30”). The sound bar device 1 is connected to the television device 3 by high-definition multimedia interface (HDMI (trademark)). The controller 2 is used for remotely controlling the sound bar device 1.

The sound bar device 1 and the controller 2 are connected to each other via an access point 4 connected to a network 5 such as a wide area network (WAN) or a local area network (LAN).

The sound bar device 1 is a so-called one-body type sound bar device that includes, in addition to a center channel speaker (CchSPK) 10-3, a left channel speaker (LchSPK) 10-1, and a right channel speaker (RchSPK) 10-2, a subwoofer channel speaker (SWchSPK) 10-4, and a surround sound audio reproduction environment can be achieved by a single sound bar device 1. However, the sound bar device 1 may be a so-called two-unit type sound bar device in which the subwoofer channel speaker 10-4 is omitted. In this case as well, a surround sound audio reproduction environment can be achieved by externally connecting the subwoofer channel speaker 10-4 to the sound bar device 1.

Further, the sound bar device 1 has, as operation modes, a normal mode of outputting the audio through use of the sound bar device 1 alone, a dual output mode of using the sound bar device 1 together with the built-in speaker 30 of the television device 3, and a test mode of generating dual output mode acoustic profile information to be used at the time of the dual output mode. In the case of the dual output mode, in accordance with the dual output mode acoustic profile information generated in the test mode, a frequency band that cannot be covered by an acoustic characteristic of the built-in speaker 30 of the television device 3 is output with respect to the audio signal to be reproduced.

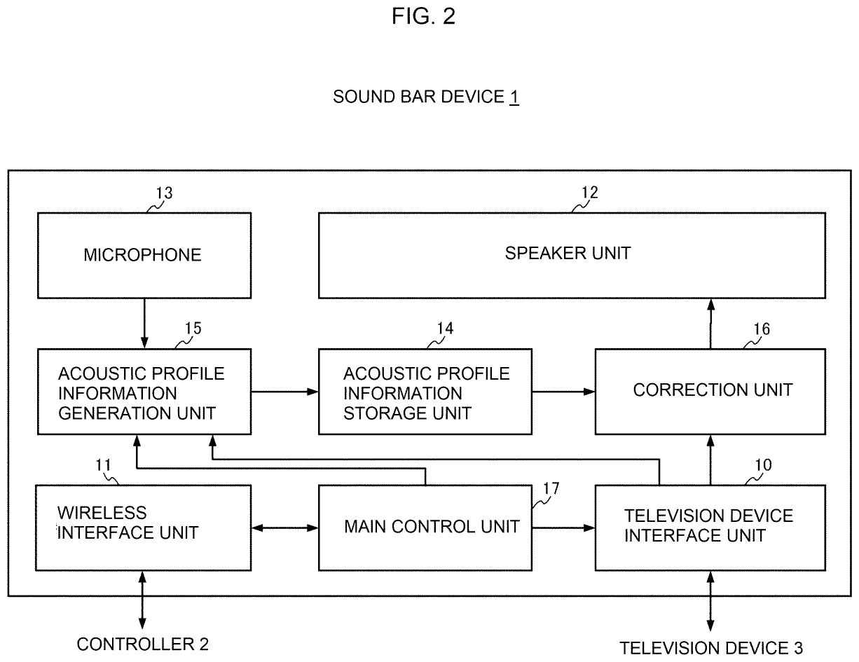

FIG. 2 is a schematic functional configuration diagram of the sound bar device 1.

As illustrated in the figure, the sound bar device 1 includes a television device interface unit 10, a wireless interface unit 11, a speaker unit 12, a microphone 13, an acoustic profile information storage unit 14, an acoustic profile information generation unit 15, a correction unit 16, and a main control unit 17.

The television device interface unit 10 is an interface unit for connecting to the television device 3 by HDMI (trademark).

The wireless interface unit 11 is a communication interface for wirelessly connecting to the access point 4.

The speaker unit 12 includes the left channel speaker 10-1, the right channel speaker 10-2, the center channel speaker 10-3, and the subwoofer channel speaker 10-4.

The microphone 13 is used for collecting the audio signal output from the built-in speaker 30 of the television device 3 in the test mode.

The acoustic profile information storage unit 14 stores the dual output mode acoustic profile information to be used at the time of the dual output mode of using the built-in speaker 30 of the television device 3 and the sound bar device 1 together. As described above, the dual output mode acoustic profile information is set such that, with respect to the audio signal to be reproduced, the frequency band that cannot be covered by the acoustic characteristic of the built-in speaker 30 of the television device 3 is output from the speaker unit 12.

When the sound bar device 1 is set to the test mode, the acoustic profile information generation unit 15 analyzes the acoustic characteristic of the audio signal input from the television device 3 via the television device interface unit 10, and collects a reproduced sound of this audio signal output from the built-in speaker 30 of the television device 3 by the microphone 13 to analyze the acoustic characteristic thereof. Then, the acoustic profile information generation unit 15 generates the dual output mode acoustic profile information based on the acoustic characteristic of this audio signal and the acoustic characteristic of the collected signal collected by the microphone 13.

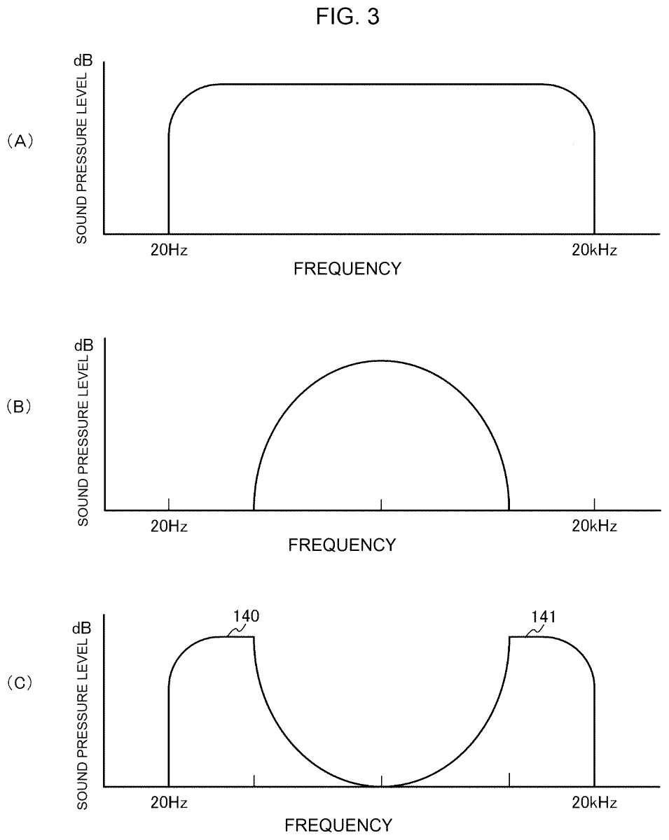

For example, when the frequency characteristic of the audio signal to be reproduced has a flat sound pressure level [dB] over the entire audible range of from 20 Hz to 20 kHz as shown in FIG. 3(A) and the frequency characteristic of the built-in speaker 30 of the television device 3 has an inverted U-shape having a peak in the vicinity of a center band of the audible range as shown in FIG. 3(B), the dual output mode acoustic profile information is generated as shown in FIG. 3(C) as a difference between the frequency characteristic of the audio signal to be reproduced and the frequency characteristic of the built-in speaker 30 of the television device 3. Thus, in order to obtain the same pattern as the frequency characteristic of the audio signal to be reproduced when the dual output mode acoustic profile information and the frequency characteristic of the built-in speaker 30 of the television device 3 are combined with each other, in a profile indicated by the dual output mode acoustic profile information, two flat-top ranges (first mountain 140 and second mountain 141) each having a flat sound pressure level [dB] appear in the audible range. The first mountain 140 has a flat peak sound pressure level [dB] in a low frequency range of the audible range, and is decreased as coming closer to the center band of the audible range. The second mountain 141 has a flat peak sound pressure level in a high frequency range of the audible range, and is decreased as coming closer to the center band of the audible range.

When the sound bar device 1 is set to the dual output mode, the correction unit 16 corrects the audio signal input from the television device 3 via the television device interface unit 10 in accordance with the dual output mode acoustic profile information stored in the acoustic profile information storage unit 14, and outputs the corrected audio signal from the speaker unit 12.

The main control unit 17 executes overall control of the units 10 to 16 of the sound bar device 1.

The function configuration of the sound bar device 1 that is illustrated in FIG. 2 may be implemented in the form of hardware by an integrated logic IC such as an application-specific integrated circuit (ASIC) or a field-programmable gate array (FPGA), or may be implemented in the form of software by a computer such as a digital signal processor (DSP). The function configuration may also be implemented as a process by a CPU by loading a predetermined program out of an auxiliary storage device onto a memory and executing the program on a general-purpose computer such as a PC including the CPU, the memory, the auxiliary storage device, which is a flash memory, a hard disk drive, or the like, an HDMI (trademark) adaptor, a wireless LAN adaptor, and a plurality of speakers.

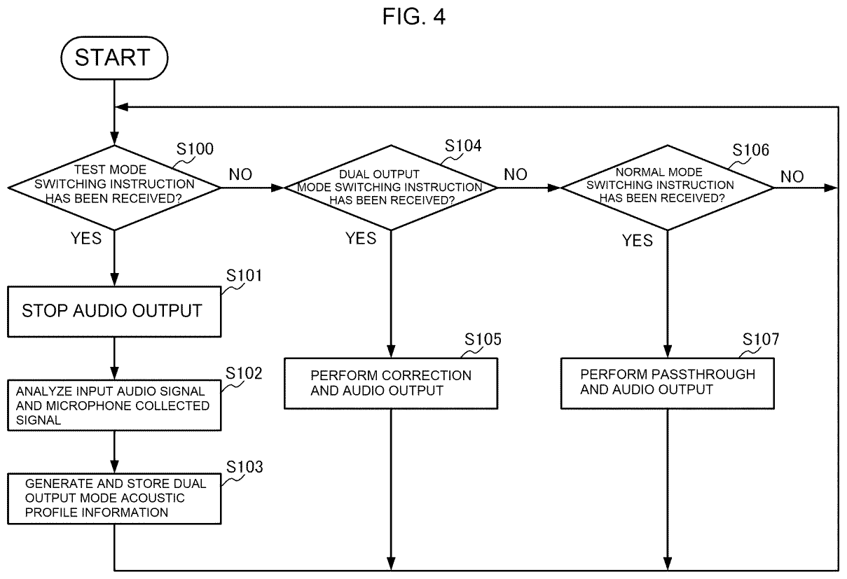

FIG. 4 is a flow chart for illustrating operation of the sound bar device 1.

Under a state in which the built-in speaker 30 of the television device 3 and the sound bar device 1 are both set to be effective as audio output destinations of the television device 3, when the controller 2 receives test mode operation from a user while the television device 3 receives and reproduces user-desired content such as a music program, the controller 2 transmits a test mode switching instruction to the sound bar device 1 via the access point 4. When the main control unit 17 receives the test mode switching instruction from the controller 2 via the wireless interface unit 11 (YES in Step S100), the main control unit 17 sets the output destination of the audio signal input to the television device interface unit 10 to the acoustic profile information generation unit 15 to stop the audio output from the speaker unit 12 (Step S101), and instructs the acoustic profile information generation unit 15 to generate the acoustic profile information.

In response thereto, the acoustic profile information generation unit 15 analyzes the acoustic characteristic of the audio signal input from the television device 3 via the television device interface unit 10, and collects the audio signal output from the built-in speaker 30 of the television device 3 by the microphone 13 to analyze the acoustic characteristic of the collected signal collected by the microphone 13 (Step S102).

Then, the acoustic profile information generation unit 15 generates the dual output mode acoustic profile information based on the acoustic characteristic of the audio signal input from the television device 3 and the acoustic characteristic of the collected signal collected by the microphone 13. Then, the acoustic profile information generation unit 15 stores the generated dual output mode acoustic profile information into the acoustic profile information storage unit 14 (Step S103).

Further, under a state in which the built-in speaker 30 of the television device 3 and the sound bar device 1 are both set to be effective as audio output of the television device 3, when the controller 2 receives dual output mode operation from the user, the controller 2 transmits a dual output mode switching instruction to the sound bar device 1 via the access point 4. When the main control unit 17 receives the dual output mode switching instruction from the controller 2 via the wireless interface unit 11 (YES in Step S104), the main control unit 17 sets the output destination of the audio signal input to the television device interface unit 10 to the correction unit 16, and instructs the correction unit 16 to correct the audio signal. In response thereto, the correction unit 16 corrects the audio signal input to the television device interface unit 10 in accordance with the dual output mode acoustic profile information stored in the acoustic profile information storage unit 14, and outputs the corrected audio signal from the speaker unit 12 (Step S105).

Further, when the controller 2 receives normal mode operation from the user, the controller 2 transmits a normal mode switching instruction to the sound bar device 1 via the access point 4. When the main control unit 17 receives the normal mode switching instruction from the controller 2 via the wireless interface unit 11 (YES in Step S106), the main control unit 17 sets the output destination of the audio signal input to the television device interface unit 10 to the correction unit 16, and instructs the correction unit 16 to allow the audio signal to pass therethrough. In response thereto, the correction unit 16 allows the audio signal input to the television device interface unit 10 to pass therethrough, and outputs the audio signal from the speaker unit 12 (Step S107).

In the above, one embodiment of the present invention has been described.

In this embodiment, in the case of the dual output mode of using the sound bar device 1 together with the built-in speaker 30 of the television device 3, the sound bar device 1 is set to output, with respect to the audio signal to be reproduced, the frequency band that cannot be covered by the acoustic characteristic of the built-in speaker 30 (see FIGS. 3). Therefore, it is possible to prevent output of a part of the frequency band from being emphasized and the sound quality from being degraded. Thus, according to this embodiment, the sound pressure can be increased while a good sound quality is maintained even when the built-in speaker 30 of the television device 3 and the sound bar device 1 are used together.

Further, in this embodiment, in the case of the test mode, the sound bar device 1 analyzes the acoustic characteristic of the audio signal input from the television device 3. In addition, the sound bar device 1 stops the audio output from the speaker unit 12, and collects the audio output from the built-in speaker 30 of the television device 3 by the microphone 13 to analyze the acoustic characteristic thereof. Then, the sound bar device 1 generates the dual output mode acoustic profile information based on the acoustic characteristic of the audio signal and the acoustic characteristic of the collected signal collected by the microphone. Thus, according to this embodiment, through execution of the test mode when the user-desired content such as a music program is received and reproduced by the television device 3, the dual output mode acoustic profile information can be generated such that the sound pressure is increased in the acoustic characteristic suitable for the content preferred by the user.

The present invention is not limited to the embodiment described above, and various modifications may be made thereto within the scope of the gist of the present invention.

For example, in the embodiment described above, in the case of the test mode, the sound bar device 1 analyzes the acoustic characteristic of the audio signal input from the television device 3. In addition, the sound bar device 1 stops the audio output from the speaker unit 12, and collects the audio output from the built-in speaker 30 of the television device 3 by the microphone 13 to analyze the acoustic characteristic thereof. Then, the sound bar device 1 generates the dual output mode acoustic profile information based on the acoustic characteristic of the audio signal and the acoustic characteristic of the collected signal collected by the microphone. However, the present invention is not limited thereto.

A test mode audio signal and also an acoustic characteristic thereof may be registered in advance in the sound bar device 1. In the case of the test mode, the sound bar device 1 may instruct the television device 3 to achieve audio input from the sound bar device 1 through use of a consumer electronics control (CEC) command, and transmit the test mode audio signal to the television device 3 to achieve audio output of the test mode audio signal from the built-in speaker 30 of the television device 3. In this case, the audio output from the speaker unit 12 is stopped, and the audio output from the built-in speaker 30 of the television device 3 is collected by the microphone 13 so that the acoustic characteristic thereof is analyzed. The dual output mode acoustic profile information can be generated based on this acoustic characteristic and the acoustic characteristic of the test mode audio signal registered in advance.

Further, in this embodiment, in the case of the dual output mode, the sound bar device 1 may synchronize a volume level of the sound bar device 1 with a volume level of the built-in speaker 30 of the television device 3. That is, the main control unit 17 regularly acquires the volume level of the built-in speaker 30 from the television device 3 through use of the CEC command, and causes the volume level of the audio signal output as audio output from the speaker unit 12 to match the latest volume level of the built-in speaker 30 acquired from the television device 3. In this manner, in the dual output mode, it is not required to individually adjust each of the volume levels of the television device 3 and the sound bar device 1, and thus the convenience is improved.

Further, in the embodiment described above, communication between the sound bar device 1 and the controller 2 is held via the access point 4. However, the present invention is not limited thereto. Communication between the sound bar device 1 and the controller 2 may be held by short-range wireless communication such as Bluetooth (trademark).

Further, in the embodiment described above, a voice recognition function may be installed in the sound bar device 1, and the sound bar device 1 may receive various instructions including the test mode, dual output mode, and normal mode switching instructions by a user's voice command input to the microphone 13.

Further, in the embodiment described above, the case in which the sound bar device 1 is combined with the television device 3 including the built-in speaker 30 has been described as an example. However, the present invention is not limited thereto. The present invention is widely applicable to a case in which the sound bar device 1 is used in combination with an audio system including a speaker.

### Reference Signs List

1: sound bar device, 2: controller, 3: television device

4: access point, 5: network

10: television device interface unit, 11: wireless interface unit

12: speaker unit, 13: microphone, 14: acoustic profile information storage unit

15: acoustic profile information generation unit, 16: correction unit, 17: main control unit

30: speaker

1. A sound bar device, which is configured to accommodate speakers of a plurality of channels in the same housing, and has a dual output mode of using the sound bar device together with an external speaker, the sound bar device comprising:
acoustic profile information storage means for storing dual output mode acoustic profile information for outputting, with respect to an audio signal to be reproduced, a frequency band that is unable to be covered by an acoustic characteristic of the external speaker; and
correction means for correcting, when the own sound bar device is set to the dual output mode, an audio signal to be output from the speakers of the plurality of channels in accordance with the dual output mode acoustic profile information stored in the acoustic profile information storage means.

2. The sound bar device according to claim 1, further comprising:
a microphone; and
acoustic profile generation means for generating the dual output mode acoustic profile information when the own sound bar device is set to a test mode, by analyzing an acoustic characteristic of an audio signal which has been input and collecting the audio signal output from the external speaker by the microphone to analyze an acoustic characteristic thereof, to thereby generate the dual output mode acoustic profile information based on the acoustic characteristic of the audio signal and the acoustic characteristic of the audio signal output from the external speaker.

3. The sound bar device according to claim 1, further comprising:
a microphone; and
acoustic profile generation means for generating the dual output mode acoustic profile information when the own sound bar device is set to a test mode, by transmitting a test audio signal having an acoustic characteristic which is registered, to the external speaker to output the test audio signal from the external speaker and collecting the test audio signal output from the external speaker by the microphone to analyze an acoustic characteristic thereof, to thereby generate the dual output mode acoustic profile information based on the acoustic characteristic of the test audio signal and the acoustic characteristic of the test audio signal output from the external speaker.

4. The sound bar device according to claim 1, further comprising control means for acquiring, when the own sound bar device is set to the dual output mode, a volume level of the external speaker and causing a volume level of the speakers of the plurality of channels to match the acquired volume level.

5. An audio system, comprising:
the sound bar device of claim 1; and
an external speaker to be used together with the sound bar device.

6. A method of setting a sound bar device, the sound bar device being configured to accommodate speakers of a plurality of channels in the same housing and having a dual output mode of using the sound bar device together with an external speaker,
the method comprising, when the own sound bar device is set to a test mode:
analyzing an acoustic characteristic of an audio signal input to the own sound bar device and collecting the audio signal output from the external speaker by a microphone to analyze an acoustic characteristic thereof, or transmitting a test audio signal having an acoustic characteristic which is registered, to the external speaker to output the test audio signal from the external speaker and collecting the test audio signal output from the external speaker by the microphone to analyze an acoustic characteristic thereof; and
generating dual output mode acoustic profile information for outputting, with respect to an audio signal to be reproduced, a frequency band that is unable to be covered by an acoustic characteristic of the external speaker, based on the acoustic characteristic of the audio signal or the test audio signal input to the own sound bar device and the acoustic characteristic of the audio signal or the test audio signal collected by the microphone,
the method further comprising, when the own sound bar device is set to the dual output mode, correcting an audio signal to be output from the speakers of the plurality of channels in accordance with the dual output mode acoustic profile information.

7. The sound bar device according to claim 2, further comprising control means for acquiring, when the own sound bar device is set to the dual output mode, a volume level of the external speaker and causing a volume level of the speakers of the plurality of channels to match the acquired volume level.

8. The sound bar device according to claim 3, further comprising control means for acquiring, when the own sound bar device is set to the dual output mode, a volume level of the external speaker and causing a volume level of the speakers of the plurality of channels to match the acquired volume level.

9. An audio system, comprising:
the sound bar device of claim 2; and
an external speaker to be used together with the sound bar device.

10. An audio system, comprising:
the sound bar device of claim 3; and
an external speaker to be used together with the sound bar device.

11. An audio system, comprising:
the sound bar device of claim 3; and
an external speaker to be used together with the sound bar device.
